(19) United States
(12) Patent Application Publication
(10) Pub. No.: US 2007/0012570 A1
(43) Pub. Date: Jan. 18, 2007

(54) Electrochemical methods for making highly soluble oxidizing agents

(75) Inventors: Paul Carus III, Peru, IL (US); J. David Genders, Elma, NY (US); Dan Hartsough, Princeton, IL (US)

Correspondence Address: Howard M. Ellis;SIMPSON & SIMPSON, PLLC, 5555 Main Street, Williamsville, NY, 14221, US

(73) Assignee: Carus Corporation, Peru, IL (US)

(21) Appl. No.: 11/486,772

(22) Filed: Jul. 14, 2006

Related U.S. Application Data
(60) Provisional application No. 60/700,202, filed on Jul. 18, 2005.

(51) Int. Cl. B01D 59/42

(52) U.S. Cl. 204/520

(57) ABSTRACT

Methods for preparing oxidizing agents having enhanced water solubility properties, such as magnesium permanganate, calcium permanganate and ammonium peroxydisulfate are prepared from oxidizing agents having more limited water solubility properties, such as potassium permanganate and potassium peroxydisulfate by electrochemical means employing oxidant stable, cationic permselective ion-exchange membranes that are also suitable for transporting a preponderance of cations with lower water of hydration, such as potassium over other more highly hydrated cations, such as sodium, magnesium and calcium used to replace the leaving potassium ion, and form more soluble oxidizer salt solutions. The methods may be practiced in multi-compartmentalized electrolytic cells, such as metathesis electrodialysis cells. The methods of the invention are also more attractive economically over previous technologies by simultaneously generating a value-added co-product without costly reagents, while avoiding the disposal of unwanted waste by-products, and the like.

### CROSS REFERENCE TO RELATED APPLICATION

This application claims the benefit of U.S. Provisional Application 60/700202, filed Jul. 18, 2005.

### TECHNICAL FIELD

This invention relates to novel electrochemical separation methods for the conversion of oxidizing agents to other, more useful oxidants and value-added co-products.

### BACKGROUND OF THE INVENTION

Oxidizing agents have a broad range of applications in the chemical, environmental, medical and consumer products industries, to name but a few. Permanganates, in particular, are used in a wide variety of applications, including in the oxidation of organic compounds in synthesis reactions, destruction of organics and other species in air and water treatment processes, detoxification and bleaching processes, surface treatments for metals, other substrates, and so on. Of the permanganate salts, potassium permanganate (KMnO₄) stands out as one of the most widely used. Methods of producing are principally chemical routes.

Potassium permanganate, however, has more limited solubility properties than other permanganate salts. Aqueous solutions of potassium permanganate are achievable only in a range of 5 or 6 percent-by-weight at room temperature. Solubilities of >40 percent-by-weight in aqueous solution are achievable with non-potassium permanganate salts, such as sodium, calcium and magnesium permanganates. Hence, the more soluble non-potassium permanganate salts are commercially desirable chemicals, and are often necessary.

Non-potassium permanganate salts are not readily available from native ores. Still, a number of methods have been described for their manufacture from readily available potassium permanganate. The first involves the so called “hexafluorosilicate method” for making sodium permanganate. While this chemical method is effective in the production of sodium permanganate, disadvantages include the generation of large quantities of an insoluble salt by-product, potassium fluorosilicate, which must be disposed or further treated. The cost of disposal and the loss of potassium values from the starting permanganate render the process less attractive.

A further method by Kotai and Bannerji disclosed in Synth. React. Inorg. Met.-Org. Chem., 31(3), 491-495 (2001) relates to the preparation of aluminum and barium permanganates from the reaction of potassium permanganate and aluminum sulfate in aqueous solution, and further reaction of aluminum permanganate with excess barium hydroxide to form barium permanganate in high purity. The by-products of aluminum sulfate, aluminum hydroxide and barium sulfate are all virtually insoluble to allow isolation of the pure barium permanganate. The barium permanganate thus formed can also be reacted with other soluble sulfate salts, such as ammonium, zinc, cadmium, magnesium and nickel to form the corresponding permanganates in high yield along with insoluble barium sulfate. Drawbacks of this process are the multiple reactions required, the cost of the chemical reagents, and the waste by-products generated, which require suitable treatment and disposal.

Ion exchange has been used for the production of liquid (calcium) permanganate. A patent for the process was issued in 1949 to T. Hagyard of Boots Pure Drug Company Ltd., (UK Patent 624,885). Solid zeolite was used to exchange the calcium cation for potassium. The process, however, did not recover the potassium value. Instead of recovering a value added co-product a waste stream of potassium chloride was generated with subsequent disposal costs.

Electrochemical membrane separation processes, also referred to as electrodialysis, metathesis electrodialysis, salt splitting, and the like, typically employ anion exchange membranes that are not stable to oxidizing agents, such as permanganate. Normally, the anion membrane would be used to transport the oxidant anion into a product stream where it would be combined with the desired cation to form a soluble permanganate salt solution. Commercially available anion exchange membranes are usually based on crosslinked; amine functionalized polystyrene divinyl benzene chains which are attacked by oxidizers resulting in increased voltage drop and loss of selectivity.

US Patent Application Publication 2006/0000713, dated Jan. 5, 2006, to Carus et al, discloses electrodialysis salt splitting methods for the production of more soluble oxidizing agents, such as calcium permanganate from less soluble oxidizing agents, like potassium permanganate. In this case, a porous separator is used in conjunction with a cation exchange membrane to split potassium permanganate, forming the more soluble permanganate salt. In order to employ a porous separator, precise pressure control must be employed to avoid excessive transport of bulk solution from one compartment to another. Since porous separators are non-selective towards any particular ion transport, current efficiencies can be low.

Accordingly, there is a need for improved, more economic electrochemical methods for the production of soluble oxidizing agents through use of more stable membranes that are also capable of providing greater permselectivity, and secondarily, for the production of useful, value added co-products without the production of large quantities of unwanted waste by-products requiring costly reagents and treatment steps for disposal.

### SUMMARY OF THE INVENTION

The present invention provides for improved more economic methods for electrochemical synthesis of soluble oxidizing agents over previous technologies wherein a value-added co-product is generated in the process without more costly reagents, disposal of unwanted by-products, and the like.

The electrochemical methods of the invention provide for separation of the original oxidant cation away from the oxidizer stream, and replacement of the original cation by a cation, such as magnesium, calcium, etc., forming a more soluble oxidizer salt solution. This separation is performed without unstable anion exchange membranes or non-selective porous separators, relying instead on the selectivity of certain cation exchange membranes, such as perfluorosulfonic acid type membranes. These membranes are suitable for transporting cations with lower water of hydration, such as potassium preferentially over other more highly hydrated cations, such as sodium, magnesium and calcium, which are used to replace the leaving potassium ion and to form a more soluble oxidizer salt solution. Other cations forming soluble oxidizer salts are contemplated. The leaving cation is not wasted, but is available to form a value added co-product, such as a base or another salt in another compartment of the cell. In the case where potassium permanganate is the original oxidant and calcium or magnesium permanganate are the desired new, more soluble oxidants, residual potassium in the permanganate product and magnesium or calcium in the co-product are readily removed via inexpensive chemical precipitation steps and may then be recycled to the process. The resultant process is simpler than typical electrochemical membrane separation methods, and the membranes employed are stable to permanganate and other oxidants.

It is therefore one principal object of the invention to provide for methods of preparing oxidizing agents having enhanced water solubility properties wherein oxidizing agents having more limited water solubility properties are the starting reactants, which method comprises the steps of:

(i) providing an electrochemical cell comprising at least one oxidant stable, cationic permselective ion-exchange membrane having greater selectivity for transporting cations from the oxidizing agent having limited water solubility than cations from the oxidizing agent having enhanced water solubility. The ion-exchange membrane divides the cell into at least two compartments, an anolyte-feed compartment housing an anode and a catholyte co-product compartment housing a cathode;

(ii) introducing into the anolyte-feed compartment a solution of the oxidizing agent having limited water solubility and an electrolyte comprising a source of cations having lower selectivity for transport across the membrane than the cations from the oxidizing agent having limited water solubility;

(iii) introducing into the catholyte co-product compartment at least an aqueous electrolyte for forming at least a base, and

(iv) conducting a reaction by applying a voltage across the anode and the cathode of the electrochemical cell to form at least the oxidizing agent having enhanced water solubility properties and a value added co-product.

The improved methods of the invention employing the oxidant stable, cationic permselective ion-exchange membranes provide mainly for the transmission of the leaving cations, e.g., potassium ions, but also some cations for imparting enhanced water solubility properties to the oxidizing agent, e.g., sodium, calcium and magnesium ions. However, the membrane favors the transmission of a preponderance of the leaving metal ions (e.g., potassium) from the starting oxidizing agent having limited water solubility.

Thus, the foregoing method includes embodiments wherein oxidizing agents having enhanced water solubility properties may be formed in the anolyte compartment of the electrochemical cell, and the value added co-product formed in the catholyte co-product compartment. Alternative embodiments are contemplated, such as electrochemical cells having three or more compartments. In such electrochemical cells having more than two compartments, the oxidizing agent having enhanced water solubility properties can be prepared in the central compartment by transmission of an alkaline earth metal ions across the cationic permselective membrane from the anolyte compartment, and so on.

Thus, it will be understood that in one aspect the methods of the invention provide for the production of oxidizing agents having enhanced water solubilities starting with oxidizing agents having limited water solubility properties, such as potassium permanganate, and through a metathesis, electrodialysis and/or salt splitting reactions, for example, to form oxidizing agents having enhanced water solubility properties, such as sodium permanganate, calcium permanganate, magnesium permanganate, to name but a few. A further representative example of an embodiment of the electrochemical methods of the invention include the conversion of potassium peroxydisulfate, a salt of limited solubility, to an oxidizing agent having enhanced water solubility properties, such as ammonium peroxydisulfate.

Still the invention contemplates the production of other oxidizing agents having improved solubilities from oxidizing agents (salts) having limited water solubilities from anions, such as bromates, chlorates, dichromates, hypochlorites, iodates, perborates, percarbonates, perchlorates, periodates, and so on.

In addition to the preparation of more soluble oxidizing agents, the methods of the invention include the simultaneous preparation of value added co-products, wherein a value added product may be generated in the catholyte co-product compartment. The introduction of an aqueous electrolyte, e.g. aqueous salt solution, during electrolysis co-generates a base of the cation of the oxidizing agent having limited water solubility properties, for instance. Alternatively, value added salts can be produced, such as by the introduction of an acid into the catholyte co-product compartment to form at least a value-added co-product with the cation of the oxidizing agent having limited water solubility properties.

The methods of the invention may be conducted either as batch or continuous processes, discussed in greater detail below.

It is still a further object of the invention to provide a method for preparing oxidizing agents having enhanced water solubility properties from oxidizing agents having limited water solubility properties by the steps, which comprise:

(i) providing a three compartment electrochemical cell comprising an anolyte feed compartment housing an anode, a catholyte co-product compartment housing a cathode and a pair of adjacent oxidant stable, cationic permselective ion-exchange membranes defining a central feed compartment stationed between the anolyte feed compartment and the catholyte co-product compartment;

(ii) introducing into the central compartment the oxidizing agent having limited water solubility;

(iii) introducing into the anolyte feed compartment a source of cations for transmission across the oxidant stable cationic permselective ion-exchange membrane to the central feed compartment;

(iv) introducing into the catholyte co-product compartment at least an aqueous electrolyte solution, and

(v) conducting a reaction by applying a voltage across the anode and the cathode of the electrochemical cell to form an oxidizing agent having enhanced water solubility properties in the central compartment and a value added co-product in the catholyte co-product compartment.

This alternative method may also generate bases, e.g., alkali metal hydroxides, from a reduction reaction occurring at the cathode and from the transmission of cations, mainly from the oxidizing agent having limited water solubility, such as potassium ions, and including to a lesser extent the transmission of alkaline earth metal ions, such as calcium and magnesium. However, other value added by-products are contemplated, including organic salts, for instance.

### BRIEF DESCRIPTION OF THE DRAWINGS

The nature and mode of the invention will now be more fully described in the following detailed description of the invention taken with the accompanying drawing figures in which:

FIG. 1 is a diagrammatic view of a two compartment electrolysis cell of the invention demonstrating the conversion of potassium permanganate to more soluble magnesium permanganate and value added co-products: potassium acetate and magnesium acetate;

FIG. 2 is a process flow diagram of the invention in a continuous mode of operation suitable for being conducted in a two or three compartment electrochemical cell, including downstream separation steps for removing potassium from magnesium permanganate and magnesium from potassium acetate, with recycle loops for returning recovered reagents to the front end of the process;

FIG. 3 is a diagrammatic view of a three compartment electrolysis cell useful for the conversion of potassium permanganate to magnesium permanganate and potassium acetate;

FIG. 4 is a graph showing the relative transport of potassium and magnesium at various feed compositions, performed in a two compartment cell equipped with a NAFION® 324 perfluorosulfonic acid cation exchange membrane, and

FIG. 5 is a diagrammatic view of a two compartment electrolysis cell useful in the conversion of potassium peroxydisulfate to ammonium peroxydisulfate with the simultaneous production useful co-products: ammonium acetate and potassium acetate.

### DESCRIPTION OF THE PREFERRED EMBODIMENTS

Thus, the novel and inventive electrochemical methods of the invention are primarily for the production of oxidizing agents having enhanced water solubility properties, and secondarily for the production of useful, value added co-products without costly disposal steps, wherein more readily available oxidizing agents perform as a principal reactant in the process. The methods are performed in an electrochemical cell configuration requiring only cationic permselective ion-exchange membrane(s) stable to oxidizing agents and possessing sufficient selectivity for the leaving cation over the transport of the new oxidant salt cation. The selectivity is deemed adequate particularly if economics, including purification and credits for co-products are favorable to traditional methods for producing oxidizers. Clean-up techniques for removal of undesired cations present due to imperfect separation are simple and inexpensive.

Methods of the invention provide for making oxidizing agents, especially oxidizing agents having enhanced properties, such as improved water solubility over the first reactant oxidizing agent. Details of the invention may be demonstrated by the following embodiments:

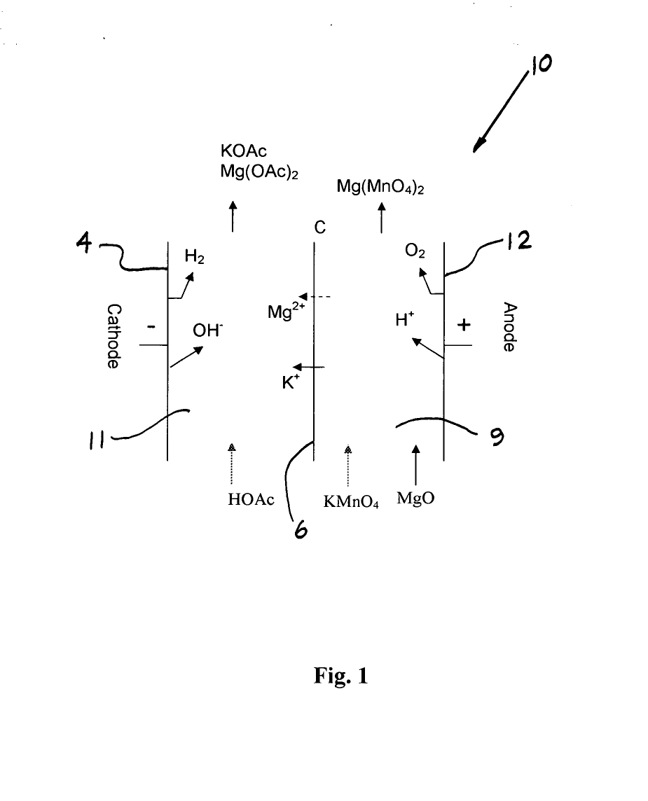

The first embodiment (FIG. 1) relates to the production of an oxidizing agent and a value added co-product in a two compartment electrochemical cell 10, sometimes referred to as a salt splitting cell. Principal components of the two compartment cell include an anode 12, cathode 14 and cationic permselective ion-exchange membrane 16 with selectivity predominantly for the first oxidizing agent cation transport, i.e., potassium ions. The two compartment electrochemical cell further comprises an anolyte or feed compartment 9 for housing the anode 12 and a catholyte or co-feed compartment 11 for housing cathode 14. The cationic permselective ion-exchange membrane 16 divides the cell into dual compartments and is commercially available through ordinary channels of commerce under the Trademark NAFION® from E.I. DuPont. This, and other such cation exchange membranes (discussed in further detail below) are stable in the presence of oxidizing agents and provide desired separation and selective transport characteristics when disposed between the feed and co-product compartments.

In practicing the methods according to FIG. 1, generally, a first oxidizing agent (KMnO₄) is dissolved in water and introduced into anolyte/feed compartment 9. Water or a heel of co-product solution for improved conductivity is introduced into the catholyte/co-product compartment 11. A voltage is impressed across the anode and cathode sufficient to produce hydroxide at the cathode and protons at the anode. The protons briefly form the acid (permanganic acid) of the oxidant in the feed stream, and then may be neutralized by an added base to form the desired oxidizing agent salt.

For example, if magnesium permanganate were the desired soluble oxidizing agent, then magnesium oxide, hydroxide, or carbonate would be added to the feed stream to immediately neutralize the permanganic acid formed at anode 12. Hydroxide ion formed at the cathode 14 may be combined with the transported cation to form a valuable base co-product. For example, if potassium permanganate were the first oxidizing agent, then transported potassium would form potassium hydroxide. Alternatively, the base formed may be reacted with an added acid to form a value added potassium salt, e.g., KOAc. Acetic acid (HOAc) may be added to the co-product chamber to form principally potassium acetate, and secondarily, some magnesium acetate.

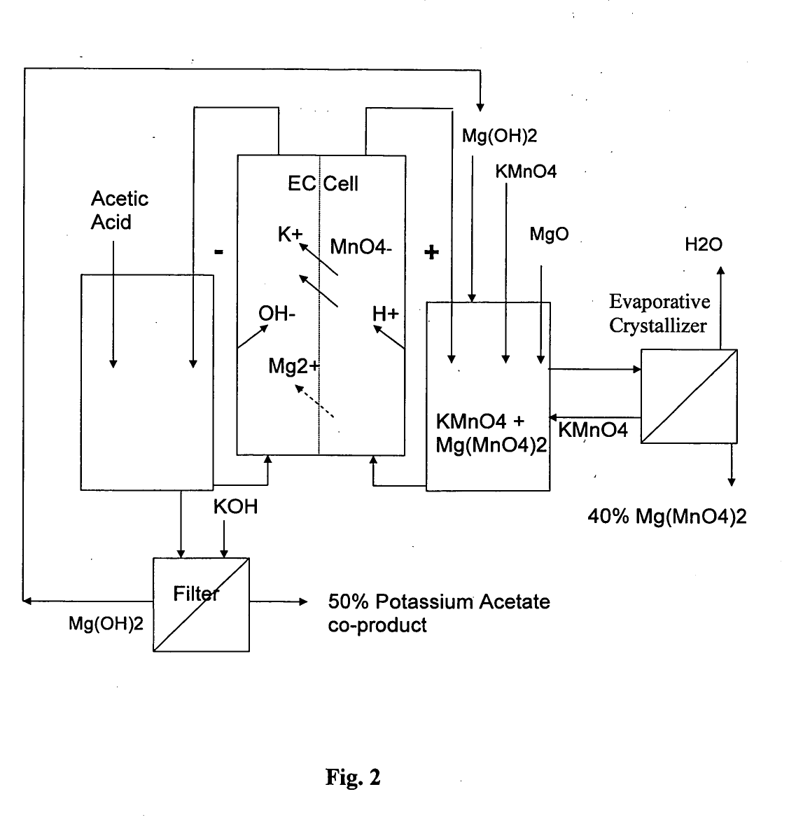

The method may also include any necessary concentration and cleanup steps to render the product (Mg(MnO₄)₂) and co-product (KOAc and Mg(OAc)₂) saleable. For example, potassium permanganate remaining unchanged in the liquid permanganate product may be conveniently removed by evaporative crystallization as it is considerably less soluble than the magnesium permanganate product, and returned to the process. Evaporative crystallization would also serve to concentrate the liquid product to the desired strength. Since the membrane will not be perfectly selective for potassium transport, the co-product will be contaminated to some degree by the new permanganate cation. For example, if magnesium permanganate and potassium acetate are being produced, some magnesium transport into the co-product stream will occur, although the perfluorosulfonate membrane favors potassium transport. Magnesium may be removed by addition of KOH to the salt co-product, precipitating the insoluble magnesium hydroxide, which may be filtered off and recycled to the process. The result is a pure stream of salt co-product, such as potassium acetate or potassium chloride. If desired, this stream may be concentrated by evaporation. (See FIG. 2)

One object of the invention is to produce a liquid permanganate salt from potassium permanganate and to recover the potassium values as a saleable co-product. FIG. 2 is a process flow diagram illustrating a continuous operation of either a two (or three) compartment embodiment wherein the liquid product is continually drawn off from the cell, concentrated and purified by evaporative crystallization. Recovered potassium permanganate is recycled and added to the cell liquor. New potassium permanganate feed is also added to the cell liquor to replace the permanganate drawn off with the product and to maintain steady state concentrations of reactants. Similarly, the co-product potassium acetate may be continually drawn off and purified by addition of KOH to precipitate Mg(OH)₂ for recycle to the permanganate feed liquor. The co-product liquor composition is maintained by electrolysis bringing potassium into the stream with acetic acid addition.

Alternatively, the process may be operated in a batch mode where the products and reactants are not drawn off and the composition of the cell liquors is allowed to change until a desired endpoint is reached.

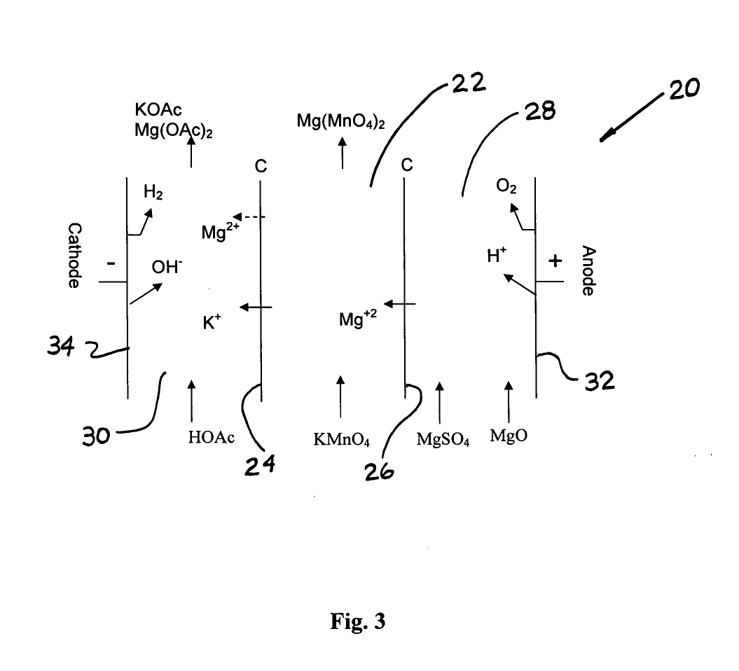

As best illustrated by FIG. 3, in some instances it may be preferable to isolate the anode from the concentrated oxidizing agent feed because of anode fouling or corrosion issues. This may be performed using a three compartment electrochemical cell 20 of FIG. 3. For example, at high temperatures, permanganic acid may be so unstable that it decomposes directly on the anode, causing fouling and voltage rise. In this case, a barrier compartment 22 is created between first and second cation exchange membranes 24 and 26, respectively. The first oxidizing agent feed (KMnO₄) is now in the central/barrier compartment 22. Cations (Mg⁺²) used to form the new oxidizing agent are supplied from the anolyte 28, and the first oxidant cations (K⁺²) are transported into the catholyte 30 as in the two compartment embodiment (FIG. 1). Base added to the anolyte (Mg⁺²) 28 neutralizes protons generated at the anode. The added cation from the base replaces that which is transported into the permanganate feed. The anolyte 28 will thus be composed of an inert salt which remains unchanged during the process. Other than the use of dual adjacent cation exchange membranes 24-26, and an inert anolyte solution 28, the three compartment embodiment of FIG. 3 is similar to the two compartment process of FIG. 1.

The three compartment process of FIG. 3 may be conducted by the steps of providing a three compartment electrochemical cell 20 having an anode 32 in the anolyte compartment 28 and a cathode 34 in a co-product compartment 30, the electrochemical cell having two cation exchange membranes 24 and 26 stable to oxidizing agents and providing desired separation characteristics disposed between the anolyte and feed and feed and co-product compartments.

The three compartment process may be practiced by the steps of introducing a solution of first oxidizing agent (KMnO₄) dissolved in water into the feed (barrier) compartment 22; introducing water or a heel of co-product solution (catholyte) 30 for improved conductivity into the co-product compartment; introducing a solution of an inert salt electrolyte into the anolyte 28 compartment. The salt will be comprised of the desired cation (Mg⁺²) used for forming the new oxidizing agent (Mg(MnO₄)₂) and an anion that will not react at the anode, such as sulfate or nitrate.

A voltage is impressed across the anode and cathode sufficient to produce hydroxide at the cathode 34 and protons at the anode 32. Acid formed at the anode is neutralized by an added base (Mg⁺²) so that the protons are not transported into the oxidizing agent compartment 22. Instead, the added metal cation is transported into the feed compartment 22 to form the desired new oxidizing agent salt. Hydroxide ion formed at the cathode may be combined with the transported cation to form a valuable base co-product (KOH). Alternatively, the base formed may be reacted with an added acid to form a value added potassium salt. For example, acetic acid may be added to the co-product chamber 30 to form potassium acetate.

Any necessary concentration and cleanup steps can be performed to render the product and co-product saleable. For example, potassium permanganate remaining unchanged in the liquid permanganate product (Mg(MnO₄)₂) may be conveniently removed by evaporative crystallization as it is considerably less soluble than the product, and returned to the process. Evaporative crystallization would also serve to concentrate the liquid product to the desired strength. Since the membrane will not be perfectly selective for potassium transport, the co-product may be contaminated to some degree by the new permanganate cation (Mg⁺²). For example, if magnesium permanganate is being produced, some magnesium transport into the co-product stream will occur, although the cation exchange membrane favors potassium transport. Magnesium may be removed by addition of KOH to the salt co-product, precipitating the insoluble magnesium hydroxide, which may be filtered off and recycled to the process. The result is a pure stream of salt co-product, such as potassium acetate or potassium chloride. If desired, this stream may be concentrated by evaporation.

The methods of the invention enable the production of oxidizing agents and valuable co-product electrochemically while avoiding the problems associated with such agents and other reactive species in cells equipped with anion-exchange membranes in salt splitting or metathesis electrodialysis. The use of porous separators requiring careful pressure control and allowing feed and product mixing are avoided.

The processes of the invention can be performed by selectively removing a cation from an oxidizing agent, replacing it with a different cation to form the “new”, chemically different oxidizing agent. The methods of the invention also provide for the co-production of one or more other value added by-products, such as salts and bases.

While details of the invention may be described with reference to a particular oxidizing agent, such as potassium permanganate, it is to be understood that this is for purposes of convenience only, and it should not be viewed as limiting as to the scope and content of the invention and appended claims. The inventive concepts disclosed herein are applicable to a wide range of substrates, namely the preparation of a broad variety of oxidizing agents with different cations and a wide variation of secondary salt by-products.

In practicing the present invention as illustrated in FIG. 1, a feed permanganate solution is prepared comprised of potassium permanganate dissolved in water. The maximum concentration of the potassium permanganate feed is highly dependent on temperature and varies from about 6% at room temperature to about 33% at 90° C. The stability of the permanganate solution decreases at high temperature and it is not desirable to run the process at temperatures greater than about 90° C. It is desirable to operate near saturation as the product concentrations will be maximized and evaporation requirements reduced.

The feed permanganate solution is introduced into the anode chamber of a two compartment electrochemical cell. The anode reaction is the production of oxygen and proton from the oxidation of water. Potassium is transported out of the anolyte compartment, across the cation exchange membrane into the catholyte co-product compartment. The electro-generated proton forms permanganic acid, an unstable intermediate which is neutralized immediately with added base, such as magnesium oxide or calcium oxide. In this manner, a more soluble permanganate salt is formed in the anolyte stream. The concentration ratio of permanganate product to potassium permanganate is maintained at a value where the efficiency of potassium transport is high and evaporation costs are not excessive. Unreacted starting material may be readily separated from soluble product by concentrating the mixture via evaporation, and cooling to crystallize out sparingly soluble potassium permanganate. The highly concentrated soluble permanganate (calcium or magnesium) is soluble to at least 50%, and will tend to “salt out” residual potassium permanganate, when cooled. The resultant liquid permanganate product is largely potassium free and at a concentration desired for the marketplace. The crystallized potassium permanganate product may be recycled to the process.

In the cathode chamber, water is reduced to form hydrogen and hydroxide. An acid is added to the catholyte compartment and maintained in excess to neutralize transported potassium plus any transported calcium or magnesium. A convenient acid is acetic acid, which will form potassium acetate, a valuable co-product used for deicing. Other acids could include common mineral acids, such as hydrochloric and nitric acid, or other organic acids chosen such that the potassium salt formed is saleable. Only acids that do not form insoluble calcium or magnesium salts are suitable. Residual calcium or magnesium in the salt co-product can be removed by adding KOH or K₂CO₃ to precipitate out the alkaline earth metal as the hydroxide or carbonate. After filtration, the alkali earth base may be recycled to the process.

The current density employed for cell operation will depend on the concentration of permanganate, which in turn depends on the solution temperature. Typically, the cell will be operated in a range between 250-4000 Am⁻².

The anode will be positioned in the feed chamber of the two compartment cell which will contain potassium permanganate feed solution. The anode reaction will be the oxidation of water to produce hydrogen and protons (Equation 1).
2H₂O→O₂+4H⁺+4e⁻ (1)

The anode must be stable to the electrolysis conditions, and may include noble metals or alloys of Pt, Pd, Ir, Au, Ru, etc., or noble metals or alloys deposited on a valve metal such as Ti or Ta, etc. The cathode in the two compartment cell embodiment will be located in the co-product chamber. The cathode reaction is the production of hydrogen and hydroxide from the reduction of water according to reaction 2.
2H₂O+2e⁻→H₂+2OH⁻ (2)

The cathode must be stable and may include carbons, noble metals and alloys, nickel, steels, etc.

According to the methods of the invention, useful electrochemical cells are compartmentalized employing virtually any oxidant stable, cationic permselective ion exchange membrane. Such membranes are well known among skilled artisans, and are available through ordinary channels of commerce. A key property of such membranes is their stability in the presence of oxidizing agents. In the case of a two compartment embodiment, a cation exchange membrane separates the feed and co-product compartments. Representative examples of useful cation exchange membranes may include perfluorinated membranes like DuPont's NAFION®; Asahi Glass' FLEMION® membranes; W.L. Gore's Gore SELECT®, or any other stable cation exchange membrane possessing the desired selectivity characteristics. Useful Nafion products include inter-alia those of the 324 or 424 series sulfonic acid based membranes, or 900 series carboxylate/sulfonate membranes used in chlor-alkali processes. The membranes will transport potassium ions economically, as compared to transporting the product cation, such as calcium or magnesium where calcium or magnesium permanganate is the desired liquid permanganate product. It is known that Nafion, for example, has a natural preference for transport of potassium over magnesium due to the smaller hydration sphere of potassium. According to A. Steck and H. L. Yeager (Anal. Chem. 52, 1215 (1980)), cations with smaller hydration energies gain relatively more energy from electrostatic interaction with the exchange site, and bind more strongly to Nafion. For the divalent metals, transport will be a two electron process, which will further improve the membrane selectivity since twice as much charge will be required to transport the divalent than to transport potassium. Therefore, significantly more potassium will be transported than magnesium or calcium from equimolar solutions of mixed metal permanganates.

For the three compartment electrochemical cell method of the invention shown in FIG. 3, the permanganate solution is fed to the central chamber of the cell, which is bounded by two cation exchange membranes. This configuration is useful when process conditions are such that the permanganic acid intermediate generated is unstable and decomposes to form manganese dioxide in the cell, thereby causing fouling and increased voltage. The metal cation forming the liquid permanganate salt is supplied from the anolyte chamber. The anolyte consists of a salt containing the desired cation to form the permanganate product and an anion which is unreactive at the anode. Sulfate and nitrate salts are typical examples.

The salt is present at high enough concentration to supply cations for transport across the membrane without encountering mass transfer limitations. High concentrations are also desirable to improve solution conductivity and reduce voltage loss. The requirements for the anode and the secondary membrane are not as stringent as in the two compartment embodiment. Namely, the anode must be stable while oxidizing water to form proton and oxygen, but need not be stable to permanganate. The anolyte cation exchange membrane must also be stable to the solutions, permanganate on one side and the anolyte salt on the other side. However, selectivity is not a requirement since the anolyte only contains one cation species.

Protons generated at the anode of the three compartment cell are neutralized in the anolyte via addition of base, such as calcium oxide or magnesium oxide after the electrochemical cell. Neutralization is done at this point to avoid proton transport across the anolyte membrane into the permanganate feed chamber, since permanganic acid would be generated and could decompose, fouling the membrane with manganese dioxide.

The following best mode working Examples of the invention will provide further enablement for practicing the invention.

### EXAMPLE 1

Production of Magnesium Permanganate and Potassium Acetate in a Two Compartment Electrochemical Cell—Batch Operation

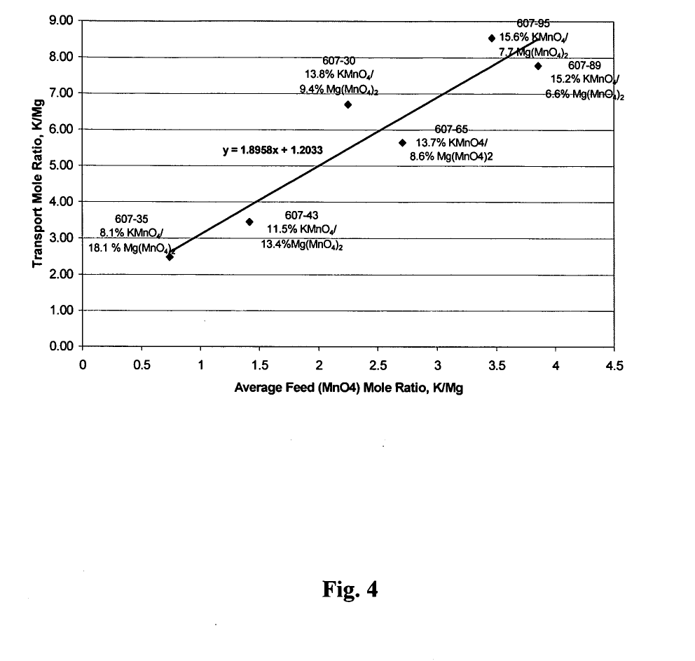

A series of batch electrolyses were performed to define the selectivity of the Nafion 324 membrane for potassium transport over magnesium transport. These two compartment experiments were performed using a MP flow cell (ElectroCell AB, Sweden) fitted with a DSA-oxygen anode, NAFION 324 membrane, and nickel cathode. The electrolysis cell corresponds to that of FIG. 1. The solution temperature was 75° C., and the current density 100-200 mA/cm². Water was electrolyzed at both anode and cathode to form H⁺ and O₂ at the anode and OH⁻ and H₂ at the cathode. Acetic acid was added to the catholyte to form potassium acetate. Electrolyses were performed at various ratios of potassium permanganate to magnesium permanganate in the feed, and the ratio of potassium acetate formed to magnesium acetate formed was determined. In each experiment, about 20% of potassium permanganate was converted. FIG. 4 illustrates the relative transport of potassium and magnesium at various feed compositions. For example, with an average feed composition of 13.8% potassium permanganate and 9.4% magnesium permanganate, a ratio of 6.7 moles of potassium per mole of magnesium were transported. The ratio of moles (K/Mg) transported vs moles (K/Mg) in the feed defines the membrane selectivity. For this set of experiments, the average selectivity is 1.9 moles potassium transported per mole of magnesium transported at equimolar concentration in the feed. This demonstrates the preference of the membrane for potassium over magnesium which allows an economic process.

### EXAMPLE 2

Production of Magnesium Permanganate and Potassium Acetate in a Two Compartment Electrochemical Cell—Continuous Operation

A continuous experiment was performed for over 400 hours wherein magnesium permanganate was drawn off periodically and replaced with solid potassium permanganate to maintain an average feed composition of 5.9% potassium permanganate and 6.7% magnesium permanganate. MgO was added to the anolyte to form magnesium permanganate. The experiment was performed using a MP flow cell (ElectroCell AB, Sweden) fitted with a DSA-oxygen anode, NAFION 324 membrane, and nickel cathode. The electrolysis cell configuration corresponded to that of FIG. 1. The solution temperature was 40° C., and the current density was 50 mA/cm². Acetic acid was added to the catholyte to form potassium acetate, at a co-product concentration of 25-35%. The magnesium acetate concentration built up to a value of about 8%. The current efficiencies for magnesium permanganate and potassium acetate formation were between 75 and 80%. The ratio of moles (K/Mg) transported vs moles (K/Mg) in the feed (average selectivity) was 5.4. 73 lbs of magnesium permanganate and 44 lbs of potassium acetate (both 100% basis) were produced during the test.

A portion of the magnesium permanganate product from the cell was concentrated by heating to 45% magnesium permanganate. The solution was then cooled in a water bath. Precipitated potassium permanganate was removed from the cooled product solution by filtration. The residual potassium level in the 45% magnesium permanganate product at room temperature was 1069 ppm, or 0.27% as potassium permanganate.

### EXAMPLE 3

Production of Calcium Permanganate and Potassium Acetate in a Two Compartment Electrochemical Cell—Batch Operation

Electrolysis was performed to define the selectivity of the NAFION 324 membrane for potassium transport vs. calcium transport. The experiment was performed using a MP flow cell (ElectroCell AB, Sweden) fitted with a DSA-oxygen anode, Nafion 324 membrane, and nickel cathode. The electrolysis cell configuration corresponded to that of FIG. 1. The solution temperature was 75° C., and the current density 100 mA/cm². Water was electrolyzed at both anode and cathode to form H⁺ and O₂ at the anode and OH⁻ and H₂ at the cathode. Acetic acid was added to the catholyte to form potassium acetate. Calcium oxide was added to the anolyte to form calcium permanganate. For an average feed composition of 15.4% potassium permanganate and 5.9% calcium permanganate, a ratio of 6.0 moles of potassium per mole of calcium was transported. The ratio of moles (K/Ca) transported vs moles (K/Ca) in the feed was 1.4 moles potassium transported per mole of calcium transported at equimolar concentration in the feed. Although the membrane selectivity is lower than in the magnesium case, the economics are still favorable to the current methods of producing liquid permanganate, because the potassium value of the KMnO₄ feedstock is recovered.

### EXAMPLE 4

Production of Sodium Permanganate and Potassium Acetate in a Three Compartment Electrochemical Cell—Continuous Operation

Electrolysis was performed in a three compartment electrochemical cell in a continuous mode to demonstrate this embodiment avoids anode fouling. Mixed sodium/potassium permanganate product was periodically drawn off and replaced with solid potassium permanganate and water to maintain a roughly constant composition. The experiment was performed in a three compartment MP flow cell (ElectroCell AB, Sweden) fitted with a DSA-oxygen anode, two NAFION 324 membranes, and nickel cathode. The electrolysis cell corresponded to that of FIG. 3. The anolyte was a two molar solution of sodium sulfate. The solution temperature was 75° C., and the current density 100 mA/cm². Water was electrolyzed at both anode and cathode to form H⁺ and O₂ at the anode and OH⁻ and H₂ at the cathode. Acetic acid was added to the catholyte to form potassium acetate. Sodium hydroxide was added to the anolyte to form sodium sulfate. Sodium was transported into the feed compartment to form sodium permanganate. In this fashion, no net chemical change occurred in the anolyte. The cell was operated for 70 hours at a stable voltage. Similar experiments in a two compartment cell could not be operated for more than one day before the voltage increased due to MnO₂ formation on the anode.

For an average feed composition of 21% potassium permanganate and 6.9% sodium permanganate, a ratio of 2.7 moles of potassium per mole of sodium was transported. The ratio of moles (K/Na) transported vs moles (K/Na) in the feed was 1.0 mole potassium transported per mole of sodium transported at equimolar concentration in the feed. This performance is the same as was observed in a two compartment cell, but anode fouling was avoided. It is recognized that sodium is not an ideal candidate for this process, since there is no simple way of removing sodium from the co-product. However, the experiment did illustrate the utility of the three compartment process for experimental conditions that promote anode fouling.

### EXAMPLE 5

Production of Ammonium Peroxydisulfate and Potassium Acetate in a Two Compartment Electrochemical Cell—Batch Operation

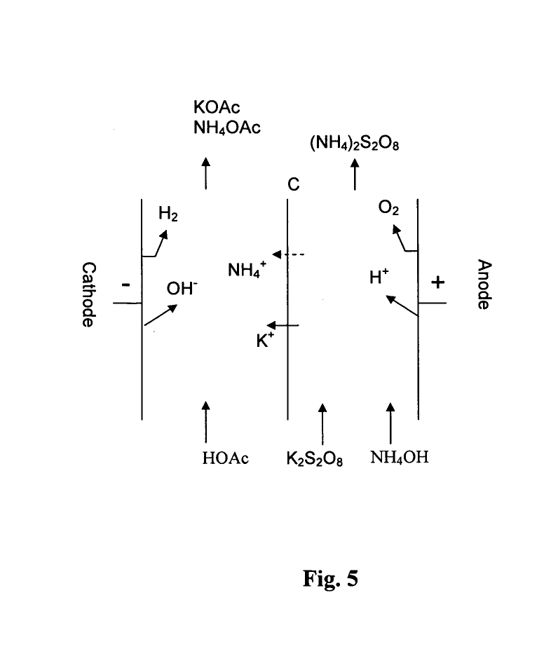

FIG. 5 shows the same two compartment cell configuration as FIG. 1, but illustrates the production of a different oxidizing agent. Potassium peroxydisulfate is only slightly soluble (6% in water at room temperature), whereas ammonium peroxydisulfate is highly soluble and is the more desirable product. The two compartment experiment is performed using a MP flow cell fitted with a DSA-oxygen anode, Nafion 324 membrane, and nickel cathode. The solution temperature is 50° C., and the current density 50 mA/cm². Water is electrolyzed at both anode and cathode to form H⁺ and O₂ at the anode and OH⁻ and H₂ at the cathode. Ammonium hydroxide is added to the peroxydisulfate to neutralize electrogenerated proton and form ammonium peroxydisulfate. Acetic acid is added to the catholyte to form potassium acetate. With an average feed composition of 10% potassium peroxydisulfate and 8.3% ammonium peroxydisulfate, a ratio of 3 moles of potassium per mole of ammonium is transported. This demonstrates the preference of the membrane for potassium over ammonium which allows an economic process.

When the ammonium peroxydisulfate product is concentrated to 40% and cooled, the residual potassium peroxydisulfate content is less than 1%. The crystallized potassium peroxydisulfate is separated from the concentrated ammonium acetate solution and recycled to the peroxydisulfate feed. Excess KOH is added to the potassium acetate co-product to raise the pH and convert ammonium acetate impurity to potassium acetate. When the solution is heated to evaporate the potassium acetate to 50%, free ammonia is driven off at the high pH. The ammonia vapor is scrubbed into the anolyte to form more ammonium peroxydisulfate. The purified potassium acetate is pH adjusted to neutral pH by addition of acetic acid and is ready for sale.

We claim:

1. A method for preparing oxidizing agents having enhanced water solubility properties from oxidizing agents having limited water solubility properties by the steps, which comprise:
(i) providing an electrochemical cell comprising at least one oxidant stable cationic permselective ion-exchange membrane having greater selectivity for transporting cations from the oxidizing agent having limited water solubility than cations from the oxidizing agent having enhanced water solubility, said ion-exchange membrane dividing said cell into at least two compartments, an anolyte-feed compartment housing an anode and a catholyte co-product compartment housing a cathode;
(ii) introducing into said anolyte-feed compartment the oxidizing agent having limited water solubility and an electrolyte comprising a source of cations having lower selectivity for transport across said membrane than the cations from said oxidizing agent having limited water solubility;
(iii) introducing into said catholyte co-product compartment at least an aqueous electrolyte, and
(iv) conducting a reaction by applying a voltage across said anode and said cathode of said electrochemical cell to form at least the oxidizing agent having enhanced water solubility properties and a value added co-product.

2. The method according to claim 1, wherein the oxidant stable cationic permselective ion-exchange membrane is characterized by transporting a preponderance of the cations from said oxidizing agent having limited water solubility relative to the cations from the electrolyte having a lower selectivity for transport across said membrane.

3. The method according to claim 1, wherein the oxidizing agent having enhanced water solubility properties is formed in said anolyte compartment, and the value added co-product is formed in said catholyte co-product compartment.

4. The method according to claim 1, wherein the oxidizing agent having limited water solubility is potassium permanganate and the oxidizing agent having enhanced water solubility properties is a member selected from the group consisting of sodium permanganate, calcium permanganate and magnesium permanganate.

5. The method according to claim 4, wherein the oxidizing agent having enhanced water solubility properties comprises from about 30 to about 60% by-weight of said oxidizing agent.

6. The method according to claim 1, wherein the oxidizing agent having limited water solubility is potassium peroxydisulfate and the oxidizing agent having enhanced water solubility properties is ammonium peroxydisulfate.

7. The method according to claim 1, wherein the oxidizing agent having limited water solubility comprises an anion selected from the group consisting of bromate, chlorate, dichromate, hypochlorite, iodate, perborate, percarbonate, perchlorate, periodate, permanganate and peroxydisulfate.

8. The method according to claim 1, wherein the value added product formed in said catholyte co-product compartment is a base of the cation of the oxidizing agent having limited water solubility properties.

9. The method according to claim 1, comprising the step of introducing an acid into said catholyte co-product compartment to form at least a value-added co-product with the cation of the oxidizing agent having limited water solubility properties.

10. The method according to claim 1, wherein the value added co-product comprising the cation of the oxidizing agent having limited water solubility properties is a member selected from the group consisting of potassium acetate, potassium chloride and potassium nitrate.

11. The method according to claim 1, which is a batch process.

12. The method according to claim 1, which is a continuous process.

13. The method according to claim 1, wherein the reaction is a member selected from the group consisting of metathesis, electrodialysis, metathesis electrodialysis and salt splitting.

14. A method for preparing oxidizing agents having enhanced water solubility properties from oxidizing agents having limited water solubility properties by the steps, which comprise:
(i) providing a three compartment electrochemical cell comprising an anolyte feed compartment housing an anode, a catholyte co-product compartment housing a cathode and adjacent oxidant stable cationic permselective ion-exchange membranes defining a central feed compartment stationed between said anolyte feed compartment and said catholyte co-product compartment;
(ii) introducing into said central compartment the oxidizing agent having limited water solubility;
(iii) introducing into said anolyte feed compartment a source of cations for transmission across said oxidant stable cationic permselective ion-exchange membrane to said central feed compartment;
(iv) introducing into said catholyte co-product compartment at least an aqueous electrolyte solution, and
(v) conducting a reaction by applying a voltage across said anode and said cathode of said electrochemical cell to form the oxidizing agent having enhanced water solubility properties in said central compartment and a value added co-product in said catholyte co-product compartment.

15. The method according to claim 14, wherein the oxidizing agent having limited water solubility is potassium permanganate and the oxidizing agent having enhanced water solubility properties is a member selected from the group consisting of sodium permanganate, calcium permanganate and magnesium permanganate.

16. The method according to claim 14, wherein the oxidizing agent having enhanced water solubility properties comprises from about 30 to about 60% by-weight of said oxidizing agent.

17. The method according to claim 14, wherein the oxidizing agent having limited water solubility properties is potassium peroxydisulfate and the oxidizing agent having enhanced water solubility properties is ammonium peroxydisulfate.

18. The method according to claim 14, wherein the oxidizing agent having limited water solubility comprises an anion selected from the group consisting of bromate, chlorate, dichromate, hypochlorite, iodate, perborate, percarbonate, perchlorate, periodate, permanganate and peroxydisulfate.

19. The method according to claim 14, wherein the value added product formed in said catholyte co-product compartment is a base of the cation of the oxidizing agent having limited water solubility properties.

20. The method according to claim 14, comprising the step of introducing an acid into said catholyte co-product compartment to form at least a value-added co-product with the cation of the oxidizing agent having limited water solubility properties.

21. The method according to claim 14, wherein the value added co-product comprising the cation of the oxidizing agent having limited water solubility properties is a member selected from the group consisting of potassium acetate, potassium chloride and potassium nitrate.

22. The method according to claim 14, which is a batch process.

23. The method according to claim 14, which is a continuous process.
